(19) United States
(12) Patent Application Publication
(10) Pub. No.: US 2006/0159232 A1
(43) Pub. Date: Jul. 20, 2006

(54) System and method for managing a communication network

(75) Inventors: Baofeng Jiang, Pleasanton, CA (US); Xidong Wu, Livermore, CA (US); Mengfeng Tsai, Fremont, CA (US); Raghvendra G. Savoor, Walnut Creek, CA (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: SBC Knowledge Ventures L.P., Reno, NV (US)

(21) Appl. No.: 11/036,668

(22) Filed: Jan. 14, 2005

(51) Int. Cl. H04M 1/24; H04M 3/08

(52) U.S. Cl. 379/1.03; 379/22

(57) ABSTRACT

A method of evaluating a performance of a communication network, such as a digital subscriber line, is discussed. At least one communication performance parameter is collected for a plurality of data objects associated with the communication network. Data objects are related to customer network connections and typically share a relation such as proximity or street address. The performance parameter of a single line is compared to the performance parameter of the related lines.

### BACKGROUND OF THE INVENTION

1. Field of the Invention

The present invention relates to the field of communications network servicing. In particular, the present invention provides a system and method for managing a communication network by analyzing the performance of related communication lines and determining a plan for addressing issues related to the performance of the related communication lines.

2. Description of the Related Art

Broadband communication networks, such as Asymmetrical Digital Subscriber Lines (ADSL), which transmit data over existing telephone lines, are typically analyzed on a per line basis. Analyzing a line can include troubleshooting a communication line's communication performance in order to repair a degraded service provided by the line, but can also include, for example, improving the capacity of an existing communication line in order to support new technologies. Also, analysis can be performed to determine feasibility of marketing strategies and product promotions for the communication line. Using current methods, performance and marketing analysis of the usually does not occur until a customer calls to request service or to complain about a problem with a network connection associated with their communication line. A “trouble ticket” is often written and a “truck roll” (sending out a repair truck to address the problem) is issued to inspect and repair the communication line after a caller registers a complaint of degraded service.

Current methods for analyzing communication lines are inefficient for several reasons. First of all, troubleshooting is usually performed on individual lines, one line at a time, without considering whether a similar problem might be occurring on a related communication line, such as a line servicing a nearby residence on the same city block. Thus, when one problem communication line is fixed, related communication lines suffering from the same problem are usually left untreated. Secondly, problematic communication lines are generally fixed on a reactive basis after a customer calls about a problem on the communication line. Such procedures generally lead to perceived poor quality of customer service offered by the service provider and lower customer satisfaction. Lower customer satisfaction can cause customers to look for alternative broadband communication services. In addition, people living in the same neighborhood may complain to each other about poor service of their communication lines such as ADSL lines, thereby creating an overall negative perception of the service provider. Mass dissatisfaction can lead to mass exodus to other competing service providers.

Loss of customers due to poor customer service can be especially frustrating if the poor service is due to a single problem that could have been resolved with a prior single maintenance effort directed at a single ADSL line, but instead went unattended. Third, since many current sales promotions are marketed to ADSL lines on an individual customer basis, these sales promotions are typically slow, inefficient and costly. If a promotion is between two service tiers, for example, and the price difference between service tiers is only a few dollars a month, there may not be enough expected profit from an individual ADSL line promotion to justify an individual promotional effort. Thus, inefficiencies of traditional communication line servicing methods have led to several problems such as higher operating cost, lower quality of service, lower customer satisfaction, potential higher customer disconnection rate, and slower and more costly product marketing and promotion processes. There is a need for a proactive method and apparatus for servicing communication lines provided in a communications network.

### SUMMARY OF THE INVENTION

The present invention provides a computerized method and apparatus for managing a communication network including a customer communication line. The present invention collects performance data for the customer communication line and for related communication lines, wherein the related communication lines are related to the customer communication line in the communication network. The present invention correlates the performance data for the customer communication line and the related communication lines and recommends a marketing or maintenance action for managing the communication network that addresses the performance of the customer communication line and the related communication lines. In one aspect of the invention, the communication lines are asymmetrical digital subscriber lines. The performance data further includes but is not limited to bit rate, signal attenuation, signal-to-noise ratio, observed crosstalk, observed echo due to tap, bit loading anomalies due to bonding, and, grounding impairment having a high degree of uniformity a neighborhood level for a communication line. The communication lines are related by physical location. The correlating customer communication lines comprises comparing the performance data for the customer communication line to at least one of the related communication lines.

Data objects containing data associated with the communication lines are stored in a relational database. A typical data object stores ADSL performance parameters associated with a customer's ADSL line. At least one performance parameter is collected for a plurality of related communication lines. Data objects for the communication line can be related, for example, because the associated network connections have a shared general location, such as a shared street, shared city block, neighborhood, etc.

The collected performance parameter data for each related communication line is correlated with the same performance parameter of the related communication line performance parameter stored in the data objects. In one instance of the present invention, a performance parameter (i.e. bit rate) for a single communication line can be compared to the same performance parameter of other related communication lines in the same general location, (i.e., same neighborhood). As a result, if a customer reports a problem with a network connection, results of the correlation can be used to identify whether the cause of the problem is occurring on one line or whether the problem should be addressed on other related communication lines within a single service call. This correlation of related communication lines leads to more effective and cost-efficient service of the communication lines in a network. Correlation can also be performed over time to determine what changing communication line conditions are responsible for a change in the quality or performance of a communication ADSL line service.

Examples of certain features of the invention have been summarized here rather broadly in order that the detailed description thereof that follows may be better understood and in order that the contributions they represent to the art may be appreciated. There are, of course, additional features of the invention that will be described hereinafter and which will form the subject of the claims appended hereto.

### BRIEF DESCRIPTION OF THE DRAWINGS

For a detailed understanding of the present invention, references should be made to the following detailed description of an exemplary embodiment, taken in conjunction with the accompanying drawings, in which like elements have been given like numerals.

FIG. 1 shows a system in accordance with an embodiment of the present invention;

FIG. 2 shows a flowchart describing one aspect of the present invention;

FIG. 3 shows a web-based result screen in one aspect of the present invention;

FIG. 4 shows a screenshot of an input screen in one aspect of the present invention; and

FIGS. 5-7 show screenshots of a Real-time Loop Performance Analyzer in one aspect of the present invention.

### DETAILED DESCRIPTION OF THE INVENTION

In view of the above, the present invention through one or more of its various aspects and/or embodiments is presented to provide one or more advantages, such as those noted below.

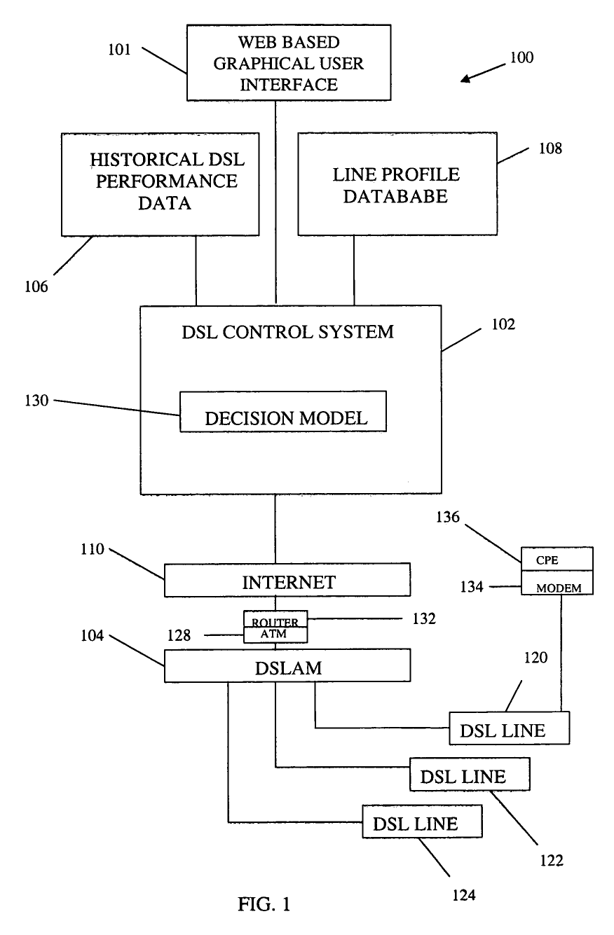

Referring to FIG. 1, a system 100 in accordance with an embodiment of the present invention is illustrated. A router 128, asynchronous transfer mode (ATM) switch 132, Digital Subscriber Line Access Multiplexer (DSLAM) 104, DSL modem 134, and customer premises equipment (CPE) 136 provide connectivity between the user and the Internet 110. A Digital Subscriber Line Access Multiplexers (DSLAM) is a mechanism at a phone company's central location that links many customer DSL connections to a single high-speed ATM line. When the phone company receives a DSL signal, an ADSL modem with a plain old telephone service (POTS) splitter detects voice calls and data. Voice calls are sent to the public switched telephone system (PSTN), and data are sent to the DSLAM, where the data passes through the ATM to the Internet, then back through the DSLAM and ADSL modem before returning to the customer's personal computer (PC). The DSLAM records ATM cell counts for each line and stores them in memory. The DSLAM 104 is coupled to the Internet 110 and couples to a plurality of DSL lines such as illustrated DSL lines 120, 122, and 124. The DSLAM receives signals from the DSL lines and connects them to the Internet using well known multiplexing techniques.

The present invention comprises a digital subscriber line (DSL) control system processor 102 coupled to the Internet 110, a line profile database storage 108, and a historical DSL performance database storage 106. The line profile database comprises a variety of data objects storing performance parameters related for each DSL line, such as DSL lines 120, 122, and 124. Performance parameters can include, among others, bit rates, signal attenuation, signal to noise ratios, observed crosstalk, observed echo due to taps, and bit loading anomalies due to bonding or grounding impairments that have a high degree of uniformity at a neighborhood level. The historical DSL performance database 106 maintains the history of DSL performance parameters associated with a customer's communication line.

The DSL control system processor 102 includes a decision model 130 for correlating performance parameters. The DSL control system 102 can be used to correlate performance parameters for a plurality of selected DSL lines. The DSL lines may be related as physically existing in the same general area such as the same street or neighborhood. DSL lines having degraded performance parameters may alternatively be determined based on historical performance data 106.

The DSL control system 102 may be implemented as a computer system that includes software to execute the decision model 130 and the DSL control system. The DSL performance database 106 and the line profile database 108 may be implemented with standard computer database technology. The DSL control system 102 collects data from one or all of the modem, CPE, ATM switch, and router. Data can be collected non-intrusively that is, data can be collected while an application is running over the DSL line for which data is being collected. The decision model selects data from the collected data.

As is well known, ADSL service architecture generally relies on pre-existing lines of the telephone distribution network. Preexisting lines generally comprise copper wire connections. Equipment is generally designed to operate at several levels of the network, from equipment designed to handle large quantities of communication lines to equipment designed for an individual user. At higher levels, a distribution plant serves multiple customers (generally from 20,000 to 40,000 phone lines). At a local level, an ADSL serving terminal generally serves about 25 phone lines. Customer lines connected to the same serving terminal are expected by general ADSL performance guidelines to have similar loop lengths (usually about 1000 feet) and to have performance parameters displaying similar performance. ADSL service rate and performance characteristics are a function of loop length, levels of attenuation, noise, observed crosstalk, etc.

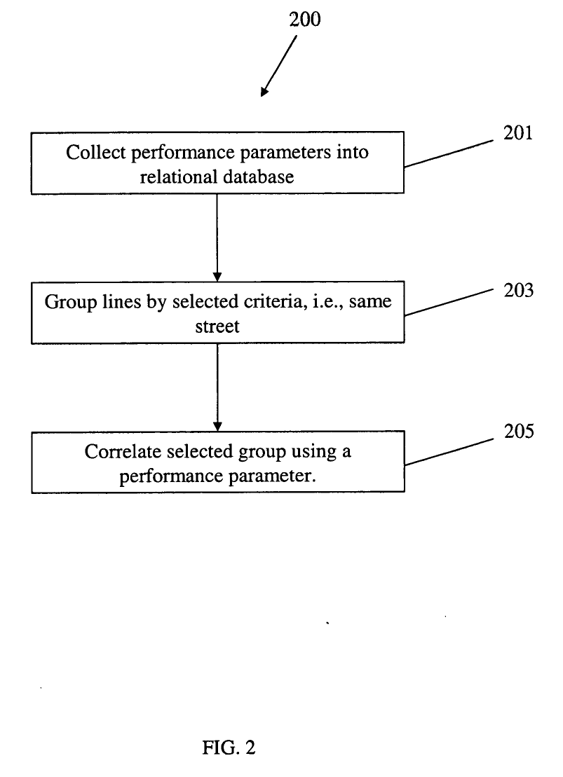

FIG. 2 shows a flowchart 200 of the present invention. Specific ADSL performance parameters are recorded as shown in Box 201. DSL performance parameters include but are not limited to upstream and downstream bit rates and error counts. Parameters can be collected, for example, during an initiation sequence for establishing an Internet connection between modem 134 and DSLAM 104, also known as “handshaking”, and are compiled most often in a periodic fashion, such as once a day or once a week. These performance parameters are stored in data objects within a relational database such as the line profile database 108. As discussed in Box 203, data objects are selected according to selection criteria chosen by an operator. A useful selection criteria is to select data objects representing lines that are physically “close” to the problematic line, i.e., share the same zip code, street, city block, etc. Physically close lines are “related” lines sharing a same general location. Other types of relationships such as similar performance parameters can be used to associate a group of “related” communication lines.

Any standard method for selecting from a database, such as Structured Query Language (SQL), can be used to perform the selection. In one aspect of the present invention, selection can be made via a Web based graphical user interface. As discussed in Box 205, performance parameters of the selected lines are correlated. In one instance, correlation can be a comparison of performance parameters among the selected data objects representing performance data for related communication lines. If another one of the selected lines exhibits similar behavior, the operator may wish to address both problems in one truck roll (i.e., one field maintenance operation). On the other hand, the operator may be alerted that a problem is not that of the individual customer, but is a result of equipment failure serving many customers. The operator can then alter a field maintenance plan appropriately to service the larger equipment failure rather than the individual line. Such correlation can lead to more proactive and efficient service.

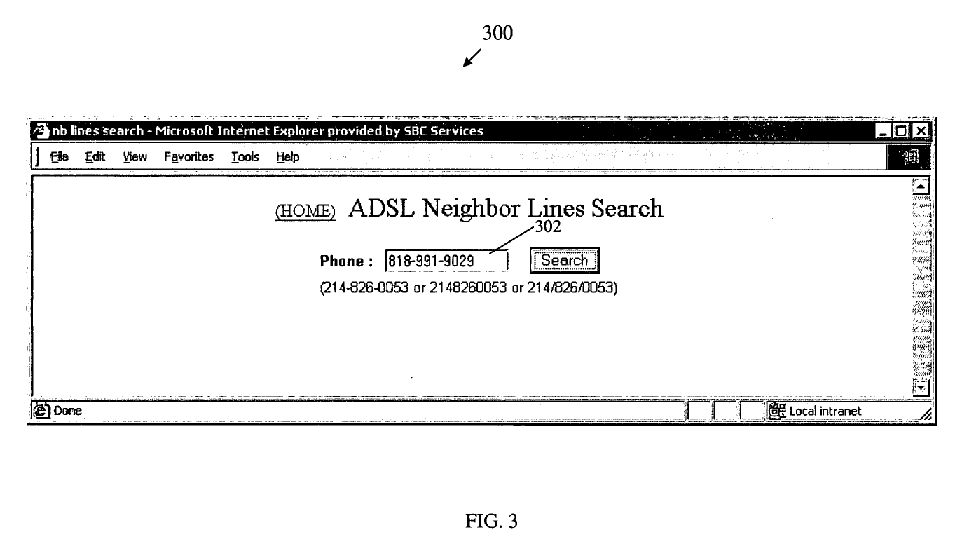

FIG. 3 shows a screenshot of an input screen 300 in one aspect of the present invention. An operator inputs a relevant selection criteria 302, i.e., the phone number of a customer reporting a network-related problem.

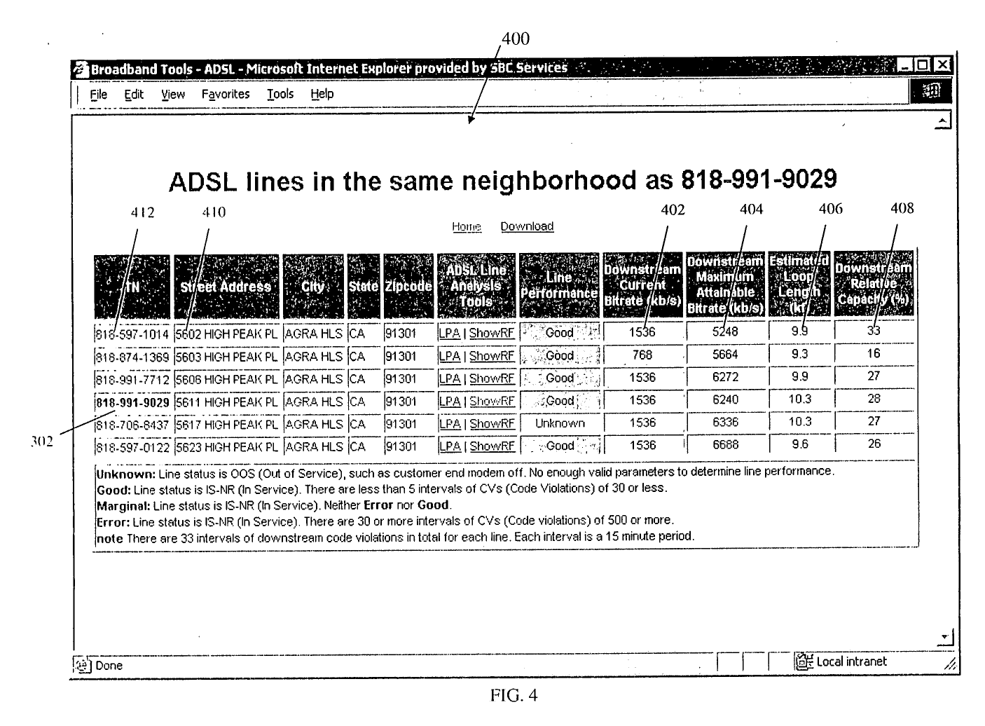

FIG. 4 shows a display screen 400 showing one possible result of performing a selection using the selection criteria input in FIG. 3. The selection criteria 302 is a DSL customer line. The search will return phone numbers of related DSL lines 412 proximate to the DSL line input 302. Proximate includes but is not limited to lines on the same street, in the same neighborhood or served by the same equipment. The returned proximate lines are “related” lines. As shown in FIG. 4 performance parameters including, but not limited to, downstream bit rate 402, downstream maximum attainable bit rate 404, estimated loop length 406 and downstream relative capacity 408 for each of the related ADSL lines. In the example of FIG. 4, related lines are those lines used by customers along the same street 410 as the input phone number 302. A correlation can then be made of ADSL performance of these related ADSL lines. Grouping the ADSL lines by physical street address and performance enables identifying and pinpointing the common causes of ADSL line performance degradation. Since performance parameters are expected to behave similarly for related lines, empirical evidence of line performance for a single line can be the leading indicator of performance for related lines.

Assuming that an ADSL line's performance is tightly coupled (highly correlated) to a group of proximate related lines, if a related line is observed to have degradation of performance, then related ADSL lines may likewise experience the same degradation. If this related ADSL degradation is observed, a proactive maintenance treatment can be performed on the related ADSL lines. For example, when an ADSL customer calls in to report a technical problem, a service technician can retrieve information on related lines. If many of these related lines show similar performance degradation, the technician can treat these related lines in one service call rather than many individual calls to each line separately. As a result, not only is greater customer satisfaction achieved by proactive treatment related lines exhibiting the same problem before their users call or even disconnect, but also it is possible to reduce the amount of trouble tickets and truck rolls. Thus, the present invention enables a single maintenance operation to benefit multiple lines. This reduces operation cost and labor cost.

In addition, it is possible to normalize higher level performance for related lines with a single integrated maintenance operation. If one or more ADSL lines is observed to have much a higher performance level than related ADSL lines, the present invention enables an operator to normalize related lines to higher performance levels.

In another aspect of the present invention, historical performance data can be maintained that statistically validates performance association or coupling between related lines (tightly coupled or loosely coupled) over time. If the performance parameters of related lines are found to diverge over time, a correlation can be made to factors within an individual living unit which can drive the divergence (e.g., inside wire, splitter or levels of micro-filter at a home, CPE differences). Thus, a determination can be made as to whether a degradation of service is attributable to an event occurring on a single line (i.e., installation of a new modem or CPE) or if the problem is related to a network component addressing many related network connections, such as a DSLAM or a router.

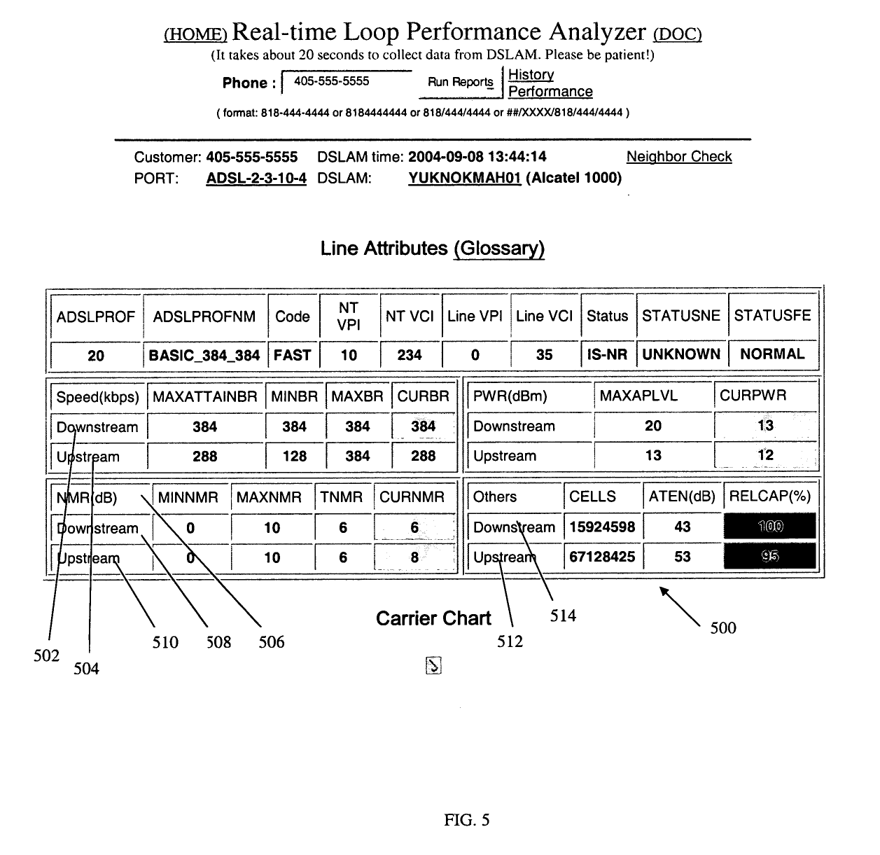

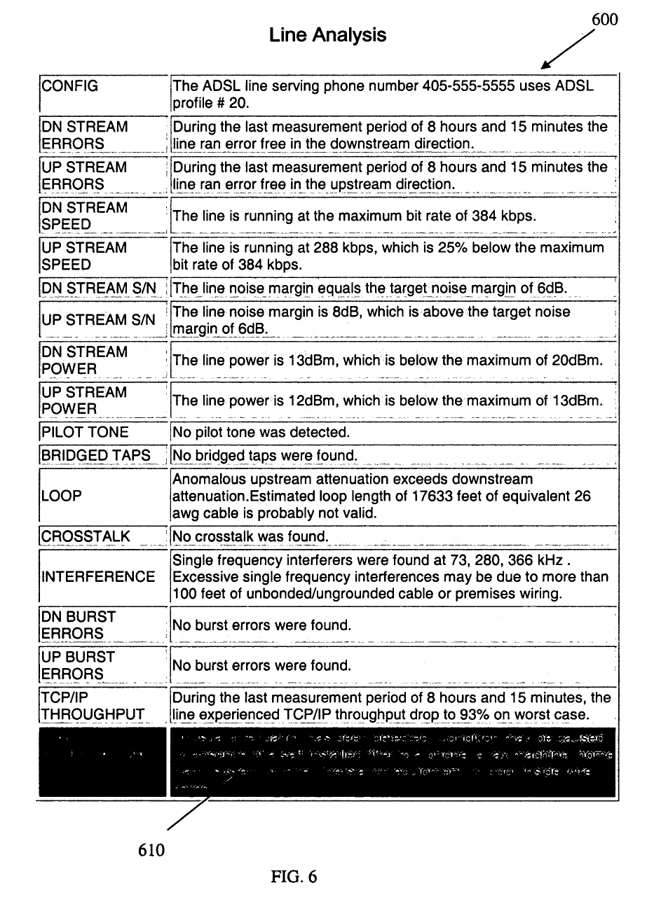

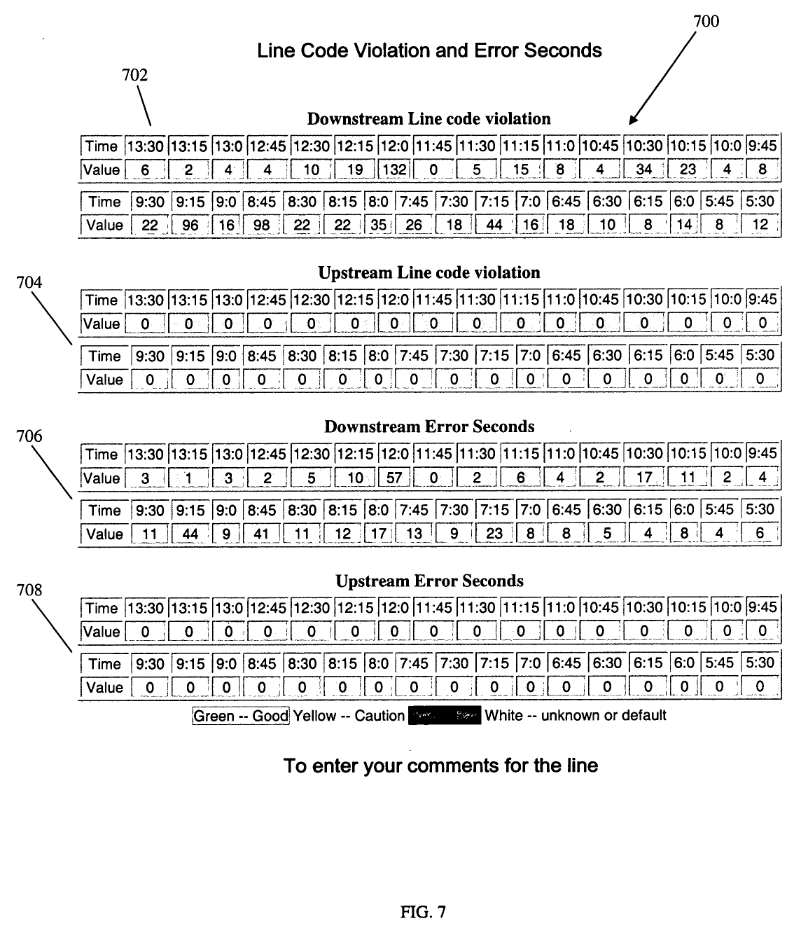

FIGS. 5-7 illustrate screenshots of data collected and displayed from a Real-time Loop Performance Analyzer in one aspect of the present invention. A real time loop performance analyzer collects performance data for a customer's communication line, such as an ADSL line. Some of the performance data categories collected shown as DSL Line Attributes are: downstream speed 502, upstream speed 504, noise levels 506 for upstream noise 508 and downstream 510 and cell counts for upstream 514 and downstream 512. Displaying raw data collected from a selected customer line, Line Analysis as shown in FIG. 5. FIG. 6 shows an analysis of the condition of a line, and a historical tracking of upstream 704 and downstream 702 Line Code Violations and upstream 708 and downstream 706 Errors (FIG. 7), which displays raw data recorded over time. As an example of an analysis output from the decision model (130 in FIG. 1), FIG. 6 displays a message (610) alerting the technician to unusual attenuation on the line as well as possible reasons for the attenuation. This analysis enables a technician to resolve a problem with improved efficiency and effectiveness.

In another aspect of the present invention, data can be used to affect product marketing and promotion processes. Usually, in order to raise a line to a higher speed, its line capacity is measured and analyzed. This is usually done on line-by-line basis. Using the present invention, marketing and sales representatives can retrieve performance data on related lines. If some of the lines have already been running at higher speed tiers and operating without technical problems, related lines can most likely also be raised to higher speed tiers as well. Marketing can therefore be targeted in a more focused manner.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

1. A computerized method for managing a communication network including a customer communication line, comprising:
collecting performance data for the customer communication line and for related communication lines, wherein the related communication lines are related to the customer communication line in the communication network;
correlating the performance data for the customer communication line and the related communication lines; and
recommending an action for managing the communication network that addresses the performance of the customer communication line and the related communication lines.

2. The method of claim 1, wherein the communication lines further comprise asymmetrical digital subscriber lines.

3. The method of claim 1, in which the performance data comprises a communication line profile.

4. The method of claim 1, wherein the performance data further comprises at least one of one of i) bit rate, ii) signal attenuation, iii) signal-to-noise ratio, iv) observed crosstalk, v) observed echo due to tap, vi) bit loading anomalies due to bonding, and, vii) grounding impairment having a high degree of uniformity a neighborhood level for a communication line.

5. The method of claim 1, wherein related communication lines are related by physical location.

6. The method of claim 1, wherein correlating customer communication lines further comprises comparing the performance data for the customer communication line to at least one of the related communication lines.

7. The method of claim 1, wherein the action comprises a maintenance action.

8. The method of claim 1, wherein the action comprises a marketing action.

9. A computer readable medium containing instructions that when executed by a computer perform a method for managing a communication network including a customer communication line, comprising:
collecting performance data for the customer communication line and for related communication lines, wherein the related communication lines are related to the customer communication line in the communication network;
correlating the performance data for the customer communication line and the related communication lines; and
recommending an action for managing the communication network that addresses the performance of the customer communication line and the related communication lines.

10. The medium of claim 9, wherein in the method the communication lines further comprise asymmetrical digital subscriber lines.

11. The medium of claim 9, wherein in the method the performance data comprises a communication line profile.

12. The medium of claim 9, wherein in the method the performance data further comprises at least one of one of i) bit rate, ii) signal attenuation, iii) signal-to-noise ratio, iv) observed crosstalk, v) observed echo due to tap, vi) bit loading anomalies due to bonding, and, vii) grounding impairment having a high degree of uniformity a neighborhood level for a communication line.

13. The medium of claim 9, wherein in the method the related communication lines are related by physical location.

14. The medium of claim 9, wherein in the method the correlating customer communication lines further comprises comparing the performance data for the customer communication line to at least one of the related communication lines.

15. The medium of claim 9, wherein in the method the action comprises a maintenance action.

16. The medium of claim 9, wherein in the method the action comprises a marketing action.

17. An apparatus for managing a communication network including a customer communication line, comprising:
a data base for storing performance data; and
a processor programmed to collect performance data for the customer communication line and for related communication lines, wherein the related communication lines are related to the customer communication line in the communication network, wherein the processor stores the performance data in the data base, the processor further programmed to correlate the performance data in the data base for the customer communication line and the related communication lines and recommend an action for managing the communication network that addresses the performance of the customer communication line and the related communication lines.

18. The apparatus of claim 17, wherein the communication lines further comprise asymmetrical digital subscriber lines.

19. The apparatus of claim 17, wherein the performance data comprises a communication line profile.

20. The apparatus of claim 17, wherein the performance data further comprises at least one of one of i) bit rate, ii) signal attenuation, iii) signal-to-noise ratio, iv) observed crosstalk, v) observed echo due to tap, vi) bit loading anomalies due to bonding, and, vii) grounding impairment having a high degree of uniformity a neighborhood level for a communication line.

21. The apparatus of claim 17, wherein related communication lines are related by physical location.

22. The apparatus of claim 17, wherein correlating customer communication lines further comprises comparing the performance data for the customer communication line to at least one of the related communication lines.

23. The apparatus of claim 17, wherein the action comprises a maintenance action.

24. The apparatus of claim 17, wherein the action comprises a marketing action.
